(19) United States
(12) Patent Application Publication
(10) Pub. No.: US 2005/0012022 A1
(43) Pub. Date: Jan. 20, 2005

(54) Optical input device with variable illumination for detecting movement on working surfaces having different optical characteristics

(75) Inventor: Zong-Xi Lin, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., Taipei (TW)

(21) Appl. No.: 10/620,554

(22) Filed: Jul. 17, 2003

(51) Int. Cl. G01J 1/32

(52) U.S. Cl. 250/205

(57) ABSTRACT

An optical input device has a light source for emitting a light beam for reflection from a working surface. The input device further includes an optical sensing module that detects the light beam reflected from the working surface, sets a coefficient indicative of an optical property of the working surface based on the reflected light, and stores the coefficient. The input device also has a control unit coupled to the optical sensing module for reading the coefficient and outputting a feedback signal based on the coefficient, and a pulse width modulator coupled to the control unit for receiving the feedback signal and, based thereon, variably modulating the light beam generated by the light source.

### BACKGROUND OF THE INVENTION

1. Field of the Invention

The present invention relates to an optical input device, and in particular, to an optical input device where the intensity of the illumination from the light source is modified during the detection of movement on a working surface.

2. Description of the Prior Art

Optical input devices, such as optical mice, are becoming more and more popular. The trend has been to replace the conventional mouse having a ball thereunder with such optical input devices. The ball of a conventional mouse rolls and moves on a working surface to detect a movement corresponding to a cursor on a display. However, the effectiveness of the conventional mouse in detecting the movement of the mouse will gradually deteriorate due to the adherence of dust or dirt on the surface of the ball as the ball rolls and moves over a period of time. Therefore, a user has to frequently remove the dust or dirt from the ball and its related mechanisms.

An optical mouse avoids the dust and dirt problem described above. FIG. 1 is a very general schematic of a conventional optical mouse 10, having a light source 12 that projects a light beam over a working surface. An optical sensing module 13 detects a reflected light (refraction) from the working surface to form a first image. If the user continues to move the optical mouse, a second image will be obtained. Therefore, the MCU (micro control unit) 14 of the optical mouse 10 will then compare the first and second images to find the differences between the first and second images and generate a corresponding cursor-moving signal for transmission to a computer. In a conventional optical mouse, the light source 12 is usually illuminated at a fixed intensity. However, the ability to effectively detect the movement of the optical mouse is dependent upon a number of factors, such as the color(s), roughness, and material(s) of the working surface. These factors will affect the reflection of light from the working surface. Sometimes, a working surface might provide poor reflection, or might provide excess reflection, all of which will result in poor images being detected for processing by the MCU 14. To address these problems, the MCU 14 in some optical input devices is equipped with an auto-adjustment function to provide preferred images to be compared.

Two known ways to upgrade the quality of the images are to modulate either a frame rate or a shutter mode. A frame rate means the number of captured images in a unit time. A shutter mode means the time consumed for capturing images at each frame rate. For each clock frequency, the frame rate is inversely proportional to the shutter mode.

The conventional optical mouse adjusts both the frame rate and the shutter mode to improve the quality of the captured images, where the shutter mode is directly controlled by a microprocessor (not shown) in the optical sensing module 13 while the MCU 12 adjusts the frame rate. However, regardless of how the frame rate and the shutter mode are modified, the conventional optical mouse 10 will still keep the intensity of the light source 12 fixed in detecting the movement of the mouse 10.

### SUMMARY OF THE DISCLOSURE

It is an object of the present invention to provide an optical input device that can effectively detect movement of the input device on a working surface for improving the cursor control in a computer display.

It is another object of the present invention to provide an optical input device that modifies the intensity of its light source to improve cursor control.

In order to accomplish the objects of the present invention, the present invention provides an optical input device having a light source for reflecting a light beam from a working surface. The input device further includes an optical sensing module that detects the reflected light beam, sets the value of a coefficient representing or indicating optical characteristics of the working surface, i.e., characteristics of the reflected light, and stores the coefficient. The input device also has a control unit coupled to the optical sensing module for reading the coefficient and outputting a feedback signal based on the coefficient, and a pulse width modulation (PWM) coupled to the control unit for receiving the feedback signal and, based thereon, modulating the light beam generated by the light source.

### BRIEF DESCRIPTION OF THE DRAWINGS

FIG. 1 is a general schematic block diagram of a conventional optical input device.

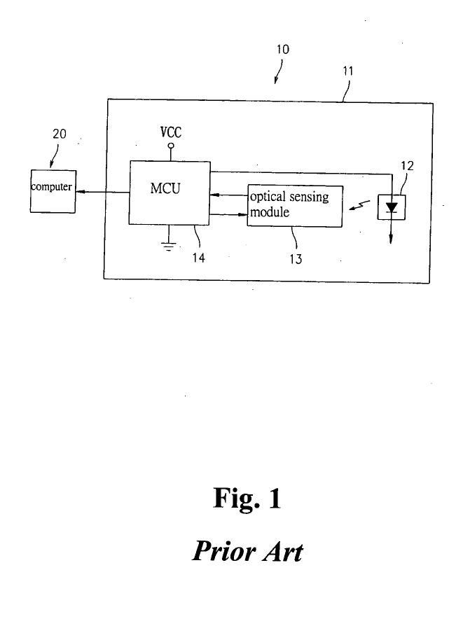

FIG. 2 is a general schematic block diagram of an optical input device according to a preferred embodiment of the present invention.

FIG. 3 is a flowchart illustrating the operation of an optical input device according to the preferred embodiment of the present invention.

### DETAILED DESCRIPTION OF THE PREFERRED EMBODIMENTS

The following detailed description is of the best presently contemplated mode of carrying out the invention. This description is not to be taken in a limiting sense, but is made merely for the purpose of illustrating general principles of embodiments of the invention. The scope of the invention is best defined by the appended claims.

The present invention provides an optical input device that has an illumination-controlling device for modulating the intensity of the light source of an optical input device so as to improve control of cursor movement on a computer display.

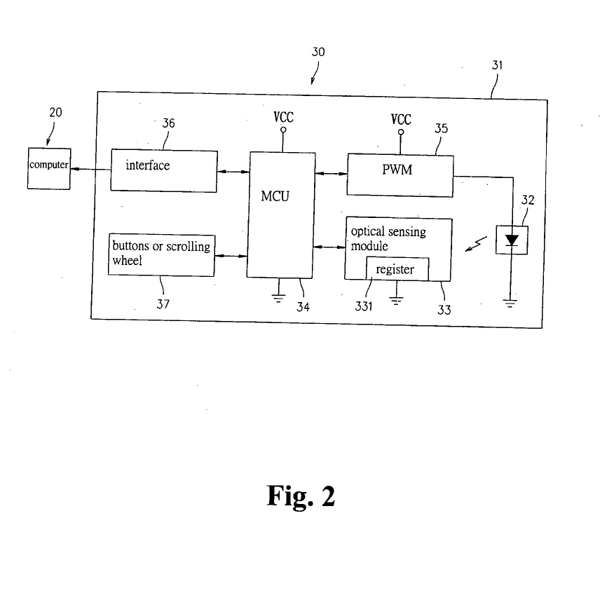

FIG. 2 is a simple schematic block diagram of an optical input device 3 (e.g., a mouse). The optical input device 30 has an optical sensing module 33 that has a register 331. The optical sensing module 33 sets the value of a coefficient called “surface quality value” (SQUAL) based on a characteristic of light emitted or projected by light source 32 and reflected from a working surface 32, and stores the SQUAL in register 331. The value of the SQUAL will vary depending on the characteristics of the working surface. As a result, as the optical input device 30 is moved over a working surface, the reflection from the working surface is detected, and based thereon, an appropriate SQUAL value is stored in the register 331. The register 331 stores the most-recent SQUAL value.

The SQUAL is a value that is determined based on experimental data. For example, when the intensity of the illumination of a light source 32 is fixed, the SQUAL may be set to zero if the working surface is black (i.e., if there is no light reflection). Similarly, the SQUAL may be set to 256 if the working surface is a mirror-liked surface (i.e., if there is full light reflection). Thus, each variation of a different material and/or color of the working surface will have a different corresponding SQUAL, so that the optical sensing module 31 will retrieve a corresponding SQUAL that represents a different specific characteristic of the working surface.

The SQUAL values in the register 331 are read by an MCU 34 that is connected to the optical sensing module 33. The MCU 34 is coupled to a pulse width modulation (PWM) 35. The MCU 34 utilizes the SQUAL value received from the optical sensing module 33 and calculates a feedback signal after comparing a present coefficient and the next one that is transmitted to the PWM 35 to further control the intensity of the illumination of the light source 32 based on the new SQUAL coefficient. When the reflection of the working surface is high, the PWM will shorten the power supply time as to reduce the intensity of light emitted by the light source. On the other hand, when the reflection of the working surface is low, the PWM will lengthen the time of power supply so as to increase the intensity of light emitted by the light source 32. Alternatively, due to the advance technology in electronics, the function of the PWM or the like can be integrated within the MCU 34.

The interface 36 can be universal serial bus (USB) or PS2 interface, using a cable to communicate with the computer 20. Also the interface 36 can be a wireless transmitter for communicating with the computer 20 wirelessly. The MCU 34 can accept signals 37 from at least a button, or a scrolling wheel.

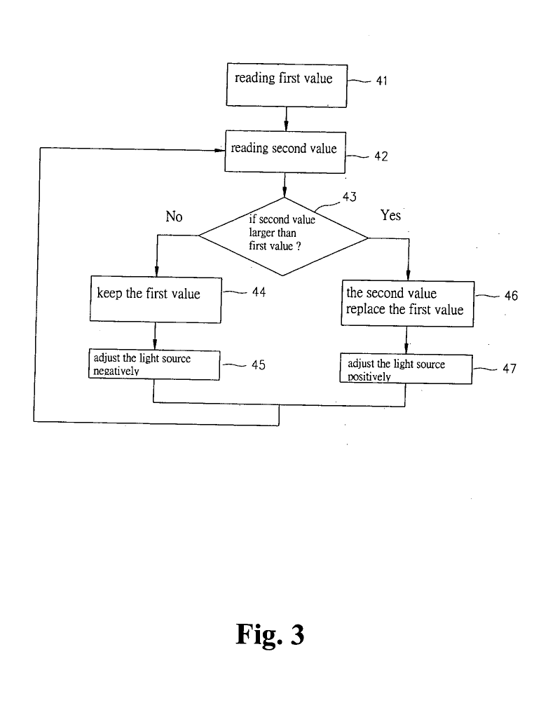

FIG. 3 is a flow chart illustrating the operation of the optical input device 30. When a user turns on a computer which is operatively connected to the optical input device 3, the MCU 34 will read a predetermined SQUAL value stored in the register 331. During execution of the flowchart of FIG. 3 (i.e., at all times while the optical input device 30 is being moved), the optical sensing module 33 will continuously detect SQUAL values and store the most-recently detected SQUAL in the register 310. In other words, the SQUAL in the register 310 will continuously be adjusted or “float” as the optical input device 3 is moved around a working surface.

In Step 41, the MCU 34 will use a predetermined value as a First value, and the MCU34 will gradually lighten the light source 32 (positively).

In Step 42, the MCU 34 will read the next SQUAL value in the register 331, either when the input device 30 is standing still or in moving state. Therefore, the next value will be defined as a Second value.

In Step 43, the MCU 34 will determine if the second value is larger than the first one? If not, the MCU proceeds to Step 44. If yes, the MCU proceeds to Step 46.

In Step 44, the MCU keeps the first value.

In Step 45, if the second value is smaller than the first one, it means the reflection of the working surface is becoming lower. Thus, the MCU 34 will generate a feedback signal to the PWM 35 so as to adjust the light source 32 “negatively.” Whereas the light source 32 had been lightened in Step 41, the present adjustment will dim the light source 32. During the progress of the adjusting loop, if a former adjustment was to dim the light source 32, then the step 45 will lighten the light source 32.

In Step 46, if the second value is larger than the first one, it means the reflection of the working surface is becoming higher, such that the second value will replace the first one.

In Step 47, the MCU 34 will generate a feedback signal to the PWM 35 so as to adjust the light source 32 “positively.” Since the light source 32 had been lightened in Step 41, the present adjustment will further lighten the light source 32. During the progress of the adjusting loop, if a former adjustment was to dim the light source 32, then the step 45 will dim the light source 32 again.

Once steps 45 or 47 have been completed, step 42 will be repeated for enabling the MCU 32 to read a new coefficient (a new second SQUAL) again.

In brief, the input device 30 according to the present invention can adjust the illumination of the light source 32 based on the different material, texture, or colors of the working surface. In addition, it can be used in combination with the known adjustments to frame rate and shutter mode, relaying on an algorithm calculated by MCU 34. The frame rate and shutter mode adjustments may be in addition to or instead of the light intensity adjustment.

The light source 32 can be operated in a power-saving or sleep mode. Once the operation of the optical input device 3 begins, the light source 32 will return to a full-lighting state. Still, this power-saving mode is not involved in the illumination variation for detecting movement on working surfaces having different optical characteristics according to the present invention.

While the description above refers to particular embodiments of the present invention, it will be understood that many modifications may be made without departing from the spirit thereof. The accompanying claims are intended to cover such modifications as would fall within the true scope and spirit of the present invention.

1. An optical input device, comprising:
a light source for reflecting a light beam from a working surface;
an optical sensing module that detects the reflected light beam, sets a coefficient based on the reflected light beam, and stores the coefficient, the coefficient indicating optical properties of the working surface;
a control unit coupled to the optical sensing module for reading the coefficient and outputting a feedback signal based on the coefficient; and
a pulse width modulation coupled to the control unit for receiving the feedback signal and, based thereon, variably modulating the light beam generated by the light source.

2. The device of claim 1, wherein the coefficient is stored in a register within the optical sensing module.

3. The device of claim 1, wherein the coefficient is a surface quality value (SQUAL).

4. The device of claim 1, wherein the light source is a light emitting diode.

5. The device of claim 1, wherein the control unit modulates a frame rate and/or a shutter mode based on the coefficient.

6. The device of claim 1, wherein the input device is an optical mouse.

7. A method of controlling the intensity of a light source in an optical input device that is moved over a working surface, comprising:
a. retrieving a first and a second coefficient that represents an optical property of the working surface based on light emitted by a light source and reflected from the working surface;
b. comparing the first and second coefficients; and
c. correcting either the present frame rate or the shutter mode, or modifying the intensity of the light emitted from the light source based on an algorithm.
